(19) United States
(12) Patent Application Publication
(10) Pub. No.: US 2017/0367309 A1
(43) Pub. Date: Dec. 28, 2017

(54) Fishing Rod Assistance Assembly

(71) Applicant: Will Morris, Kingstree, SC (US)

(72) Inventor: Will Morris, Kingstree, SC (US)

(21) Appl. No.: 15/193,318

(22) Filed: Jun. 27, 2016

(51) Int. Cl. A01K 87/08; A01K 87/02; A01K 87/00

(52) U.S. Cl. CPC A01K 87/08; A01K 87/007; A01K 87/02

(57) ABSTRACT

A fishing rod assistance assembly having a base assembly. A rod opening defined in the base for receiving a fishing rod and securing the invention to the rod. A handle assembly can be attached to the base assembly. A handhold space can be defined in the handle assembly for allowing fishing line to pass through the handhold space and be extended out and reeled in. A handle angle can be in the 100° to 180° when the handle is placed in a rearward position. A tool holder included in the lower base for receiving and removably securing a fastening tool to the lower base.

### BACKGROUND OF THE INVENTION

### 1. Field of the Invention

This invention is directed to a removable rod assistance assembly that does not interfere with re-lining the rod and can assist with increasing mechanical advantage when reeling in a fish.

### 2. Description of the Related Art

In fishing, particularly deep sea fishing, the force of “fighting” the fish and reeling in the fish can be significant. One aspect of the technique involves lifting the rod as if you are pointing the top of the rod skywards also know as pump action. This pump action requires the fisherman to pull the portion of the rod forward, the reel upwards, reel in the line, allow the rod to drop, and repeat the process. It requires force to be placed on the rod, forward the reel, to lift this portion of the rod upwards. It is common for the rod to significantly bend under the force. In handling a rod with the force of the fish “fighting”, attempts to increase the mechanical advantage of the fisherman has been tried.

There have been other attempts to provide a handle, but these prior attempts do not have a sufficient structure to provide the advantageous functions of the present invention. For example, United States Patent Application Publication 2012/0255215, a handle system for use with a fishing rod but requires the line to be placed through an eyelet of the invention requiring removal of the fishing line when the handle is removed. U.S. Pat. No. 6,237,274 discloses a fishing rod handle attachment but requires the line to be fed through an enclosed portion of the handle again preventing removal of the handle unless the line is removed. The same disadvantage is present in Design Patent D447,534.

Therefore it is an object of the present invention to provide for a rod assistance assembly that increases the mechanical advantage of the rod when reeling in a fish.

It is another object of the present invention to allow the handle to be removed without having to remove the fishing line from the rod.

It is another object of the present invention to provide for a detachable handle assembly that can be selectively angled forward or rearward.

### BRIEF SUMMARY OF THE INVENTION

The objects above are achieved by providing a rod assistance assembly comprising: an upper base being generally laterally disposed (perpendicular) when attached to a fishing rod; a lateral vertical member attached to the upper base extending upwards from the upper base; a handle attached to the vertical member; a space for receiving a fishing line defined by the upper base; lateral vertical member and handle; and, a lower base removably attached to the upper base for securing a fishing rod between the upper base and the lower base.

The invention can include a base assembly having an upper base wherein the upper base includes an upper concave portion; a lower base included in the base assembly configured for attachment to the upper base wherein the lower base includes a lower concave portion; a rod opening defined by the upper concave portion and the lower concave portion; a handle assembly attached to the upper base having a lateral vertical member and handle; a handhold space defined by the upper base, lateral vertical member and handle wherein the rod opening is dispose beneath the handhold space and the handhold space width extends beyond the diameter of the rod opening; a handle angle in the range of 100° to 180° defined by a lateral vertical member line and a vertical line at a right angle to a bore line; a lateral inner wall defined in the lower concave portion of the lower base configured to contact the fishing rod and apply compressive force to secure the rod in the rod opening; and, a tool holder included in the lower base for receiving and removably securing a fastening tool to the lower base.

The invention can also include an upper member removably attached to the upper base and lateral vertical member so that the handle can be removed from the base. A hinge can be included and configured to secure a rotating end of the lower base to the upper base and allowing a free end of the lower to rotate away from the upper base so that the fishing rod can be received in the rod opening. A rearward or forward extension can be included for contacting the fishing rod and configured to increase leverage on the fishing rod when the handle is pulled upwards.

A bolt opening can be defined in the lower base and the upper base for receiving a bolt to secure the lower base to the upper base wherein the bolt openings have a length wise bore that is perpendicular to a lengthwise axis extending through a bore defined by the rod opening. The rod opening can include a lower flat area defined in the lower base.

### BRIEF DESCRIPTION OF THE DRAWINGS

The description of the invention will be explained with reference to the following figures:

FIG. 1 is a perspective view of the invention attached to a rod;

FIG. 2 is an elevation view of aspects of the invention;

FIGS. 3A through 3D are elevation view of aspects of the invention;

FIG. 4 is a perceptive view of aspects of the invention;

FIG. 5A is an elevation view of aspects of the invention;

FIG. 5B is a perspective view of aspects of the invention; and,

FIG. 6 is a perspective view of aspects of the invention.

### DETAILED DESCRIPTION OF THE INVENTION

In general the terms and phrases used herein have their art-recognized meaning, which can be found by reference to standard texts, journal references and contexts known to those skilled in the art.

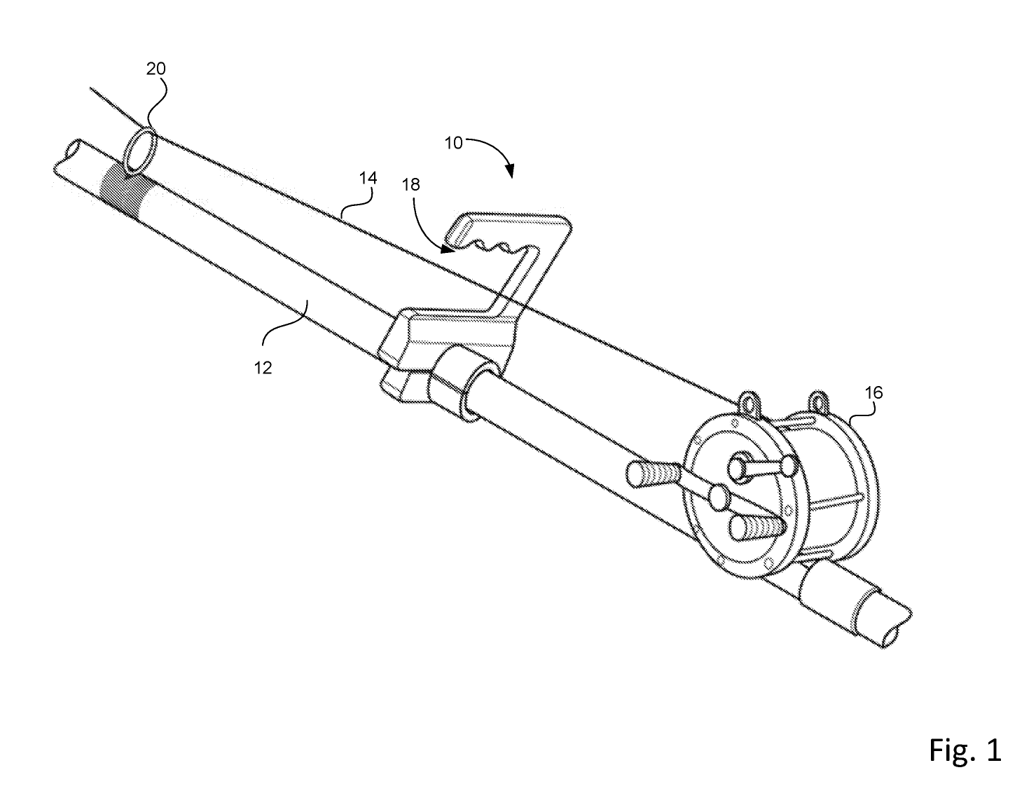

Referring to FIG. 1, the rod assistance assembly 10 is shown carried by rod 12. A line 14 that originates with reel 16 passes through a space 18 defined in the rod assistance assembly. The line can extend through the space and through a fishing rod guide 20 that is attached to the rod.

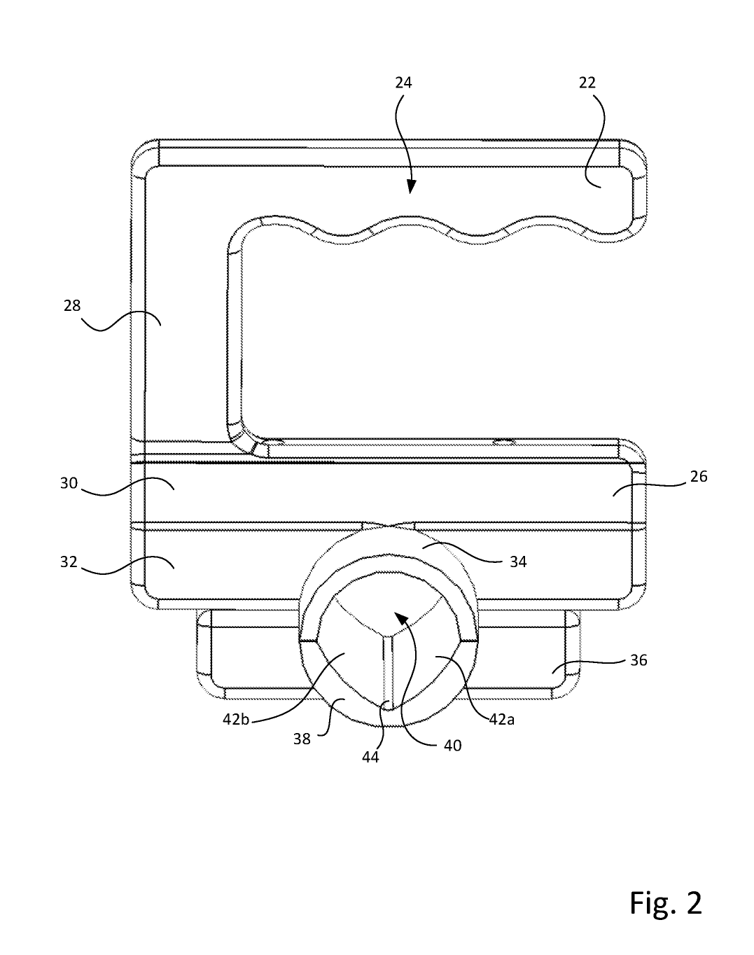

Referring to FIG. 2, the rob assistance assembly can include a handle 22 that can include finger indentions 24. The handle can be connected to an upper base 26 by a lateral vertical member 28. The upper base, handle and lateral vertical member can define the space for receiving a line. This arrangement allowed the fishing rod to be relined without having to remove the rod assistance assembly.

The upper base can include a upper member 30 and a lower member 32. The upper member can include an upper concave portion 34 for receiving a portion of the fishing rod. The upper concave portion can be semi-circular in one embodiment. A lower base 36 can be removably attached to the upper base. The lower base can include a lower concave portion 38 that can receive a portion of the fishing rod. In one embodiment, the lower concave portion is semi-circular so that a rod opening 40 is defined between the upper and lower base to receive the fishing rod.

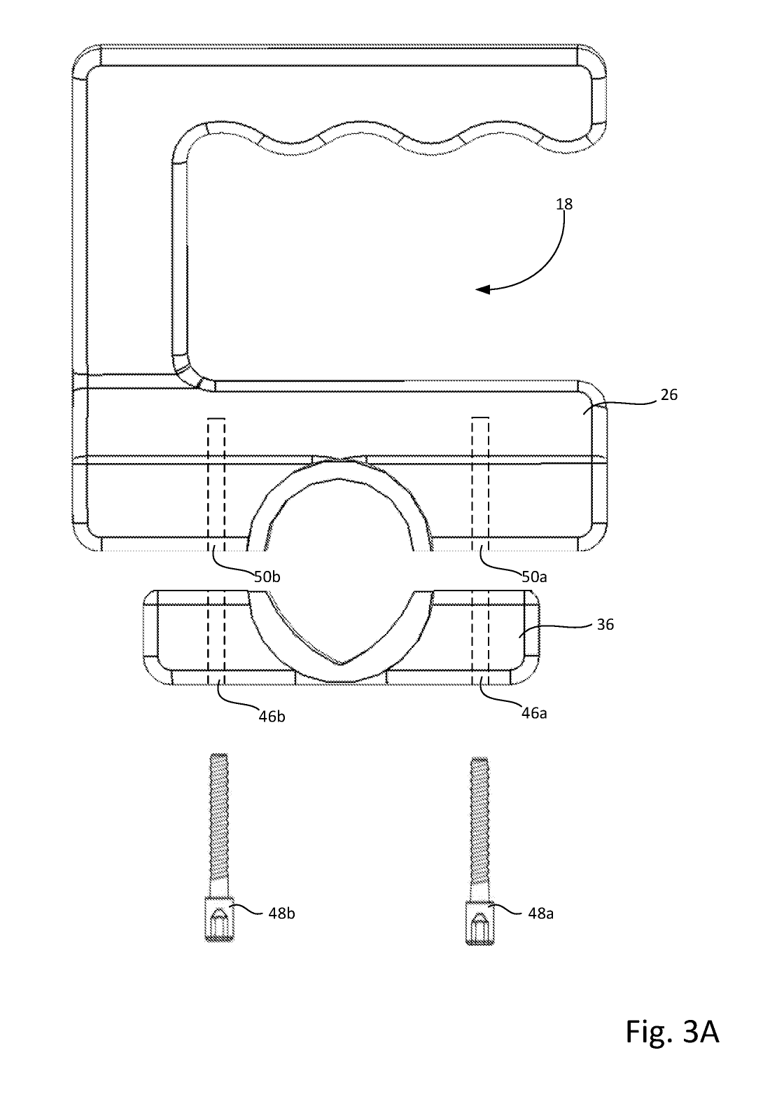

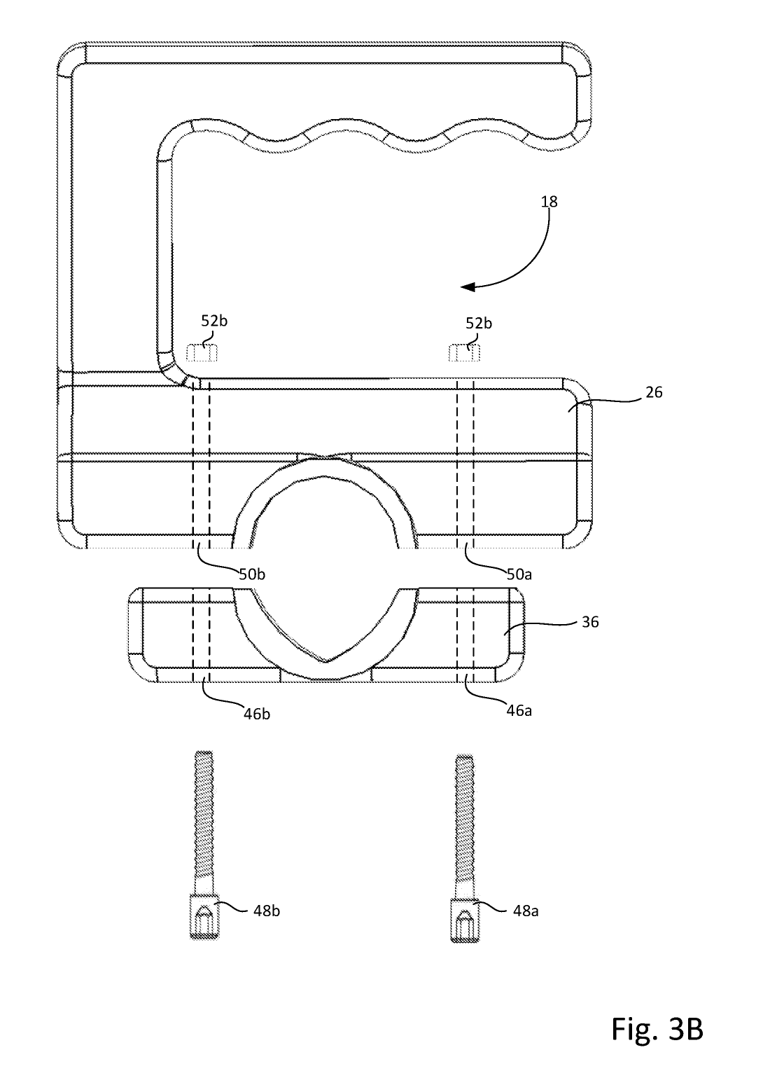

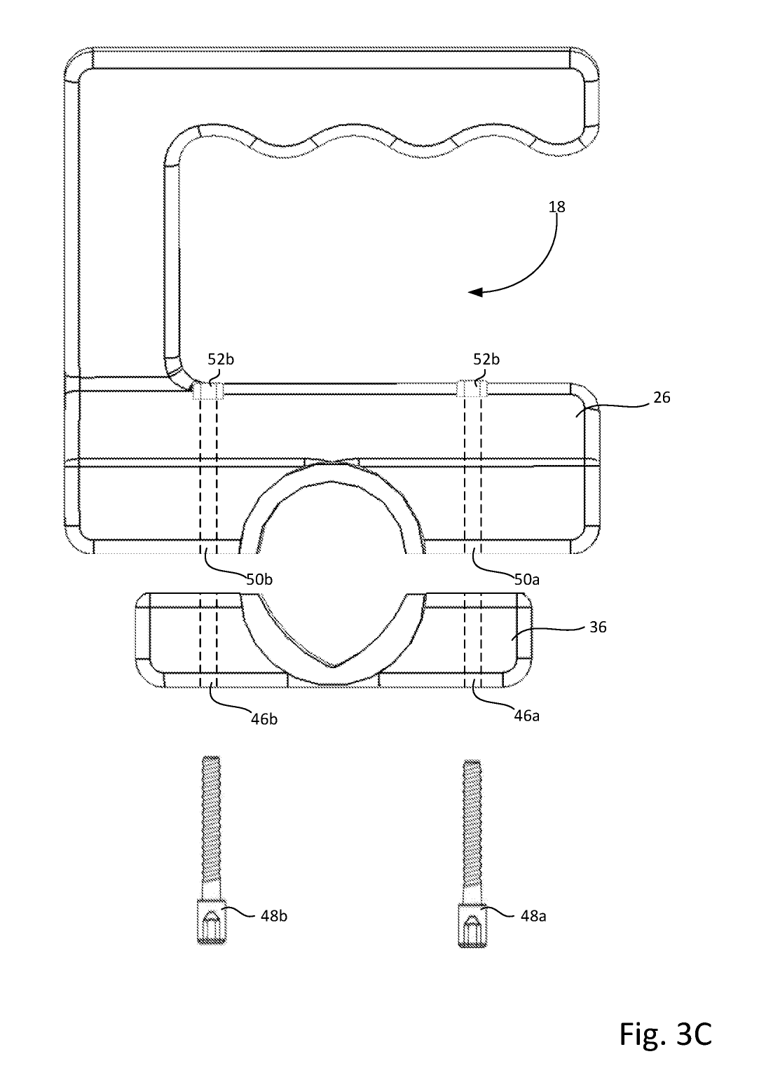

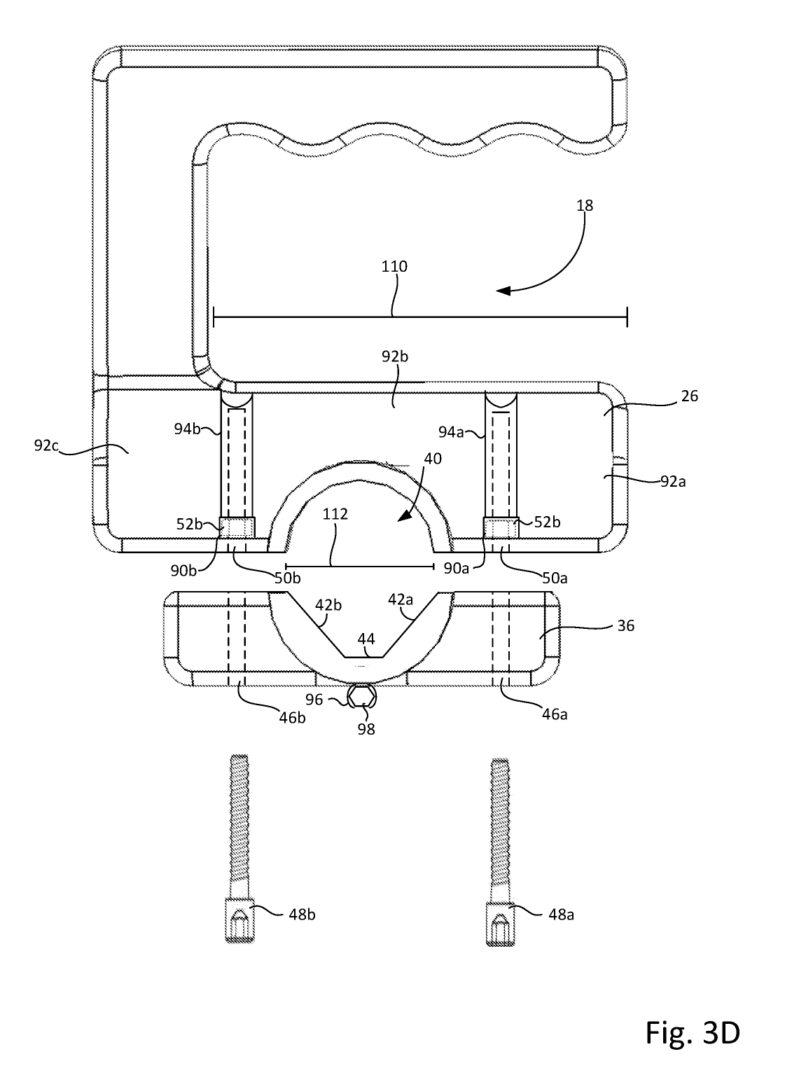

In one embodiment, the lower base includes lateral slanted inner walls 42a and 42b wherein each can include a concave arc (FIG. 2) or lateral slanted inner walls where the walls are generally flat (FIG. 3D). The walls can abut at a lower portion of the lower base or join at a lower flat area 44. When the rod is received in the rod opening 40 and the lower base is attached and tightened to the upper base, the wall contacts the fishing rod to secure the rod assistance assembly to the rod. The walls allow for differing fishing rod diameters to be received in the opening and for the upper and lower base to be tightened against the differing diameter rods. With the slanted walls, it is not necessary that the lower base and upper base contact each other to secure the rod in the opening.

Referring to FIGS. 3A to 3C, the lower base can be secured to the upper base with a fastening assembly. In one embodiment, the fastening assembly can cooperatively associate with the lower base that can include one or more bolt openings such as 46a and 46b for receiving bolts 48a and 48b. The lower base bolt opening can either include threads corresponding to the threads of the bolts or can be smooth to allow the bolts to freely travel into the lower base bolt opening. The upper base can include bolt openings 50a and 50b so that when the bolts extend through the lower base, they can be received into the upper base bolt opening. The upper base bolt openings can be recessed a distance 52a and 52b from the upper edge of the upper base so that the bolts do not extend into space 18. In one embodiment (FIG. 3B), the bolt can extend into space 18 and can secure the upper base to the lower base with nuts 52a and 52b attached to the distal end of the bolt in space 18. In one embodiment (FIG. 3C), the nuts are recessed into the top edge of the upper base. The bolts can extend below the lower base or can be recessed into the lower base.

Referring to FIG. 3D, nut opening 90a and 90b can be defined in the upper base to allow the nuts to be received in the upper base from the side of the upper base. When the bolts are received into the lower base, nut and upper base, the nuts are held in place in the upper base. The upper base can include voids 92a through 93c. These recesses can define protrusions 94a and 94b that allow the bolts to be contained interior to the upper base when extending into the upper base. The recess allow for the reduction in raw material when making the invention without negatively effecting the strength of the invention and allowing the bolts to be contained within the upper base.

The handle space 18, defined by the handle, lateral vertical member, and upper base, can include a width 110. The rod opening 40 be disposed beneath the handle opening. The rod opening 40 can include a diameter 112 that is disposed below and between the width of the handle opening.

In one embodiment, the bolts can be rotated with the assistance of a fastening tool such as a screw driver or hex key or wrench. However, it is inconvenient when the tool is misplaced. Therefore, the lower base can include a tool holder 96 for holding a tool 98 to the invention. The tool holder can include lateral walls defining an tool opening for receiving the tool along the long axis of the lower base. The length of the tool can generally coincide with the width of the lower base so as to allow the tool to be stored without interfering with the operation of the invention. When needed, the tool is remove from the tool holder when needed and replaced when not in use.

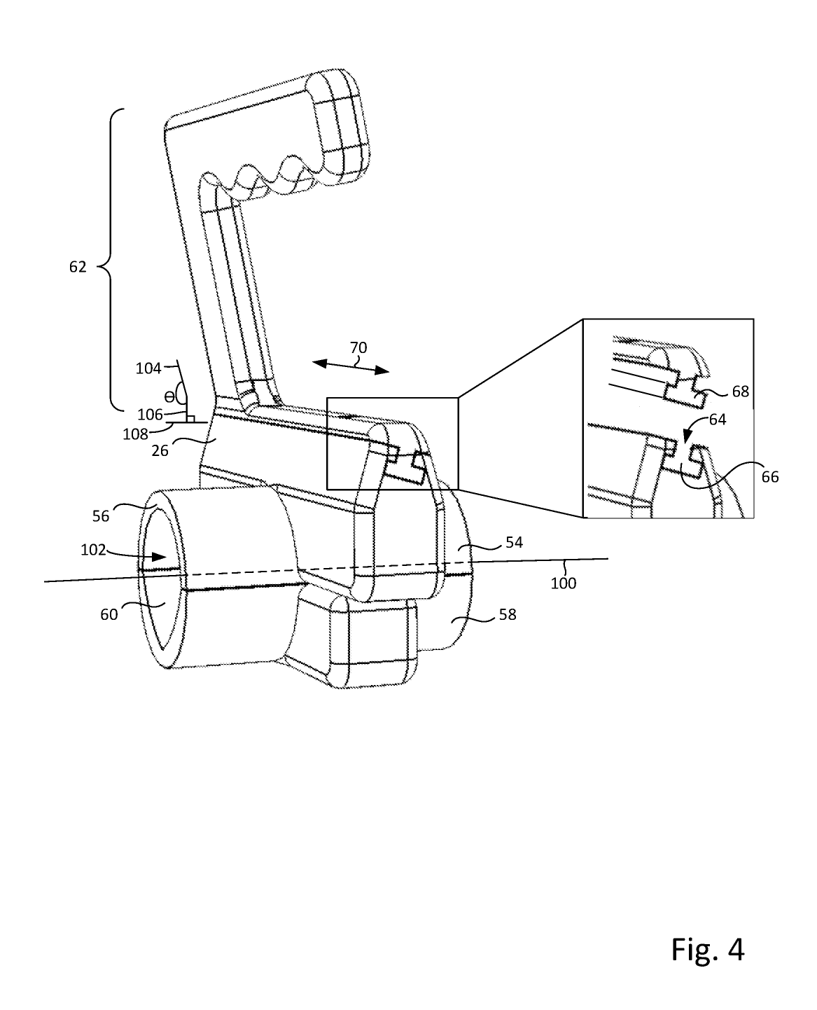

Referring to FIG. 4, the upper base can include a forward extension that can include an upper forward extension 54, a lower forward extension 58 or both. The upper base can include a rearward extension that can include upper rearward extension 56, a lower rearward extension 60 or both. The extensions can assist with stabilization of the rod assistance assembly when attached to the rod. The extension can also increase the leverage placed on the rod to increase the mechanical efficient of the user pulling upward on the handle.

The slanted inner walls of the lower base can extend partially or completely through the opening defined by the forward extension and the rearward extensions. The invention can include the forward extensions, rearward extensions or both.

In one embodiment, a handle assembly 62 can be removably attached to the upper base. The upper base can include a slot 64 that can include a track 66. The track can be shaped such as a “T” slot, dove tail, circular, angled, or any combination thereof. The handle assembly can include a rail 68 that is received into the track so that when the handle is pulled upward, the handle is not removed from the upper base. The handle assembly is attached to the upper base by sliding the rail into the track in a direction shown as 70. In one embodiment, the handle is at a handle angle θ to a line orthogonal to lengthwise axis 100 extending through the bore 102 defined by the upper and lower base for receiving the fishing rod. The angle can be less than 180° so that the handle is tilted rearward in a rearward position or when the handle is turned 180° and installed angled forward, θ is greater than 180° in a forward position. In one embodiment, the handle angle in the range of 100° to 180° defined by a handle angle line 104, lateral vertical member line 106 and a vertical line at a right angle to a bore line 108.

The handle can be installed with handle space 18 opening to the right of the left in relation to the rod direction. In one embodiment, the bolts extend through the lower base, upper base and into the handle assembly further securing the handle assembly to the upper base.

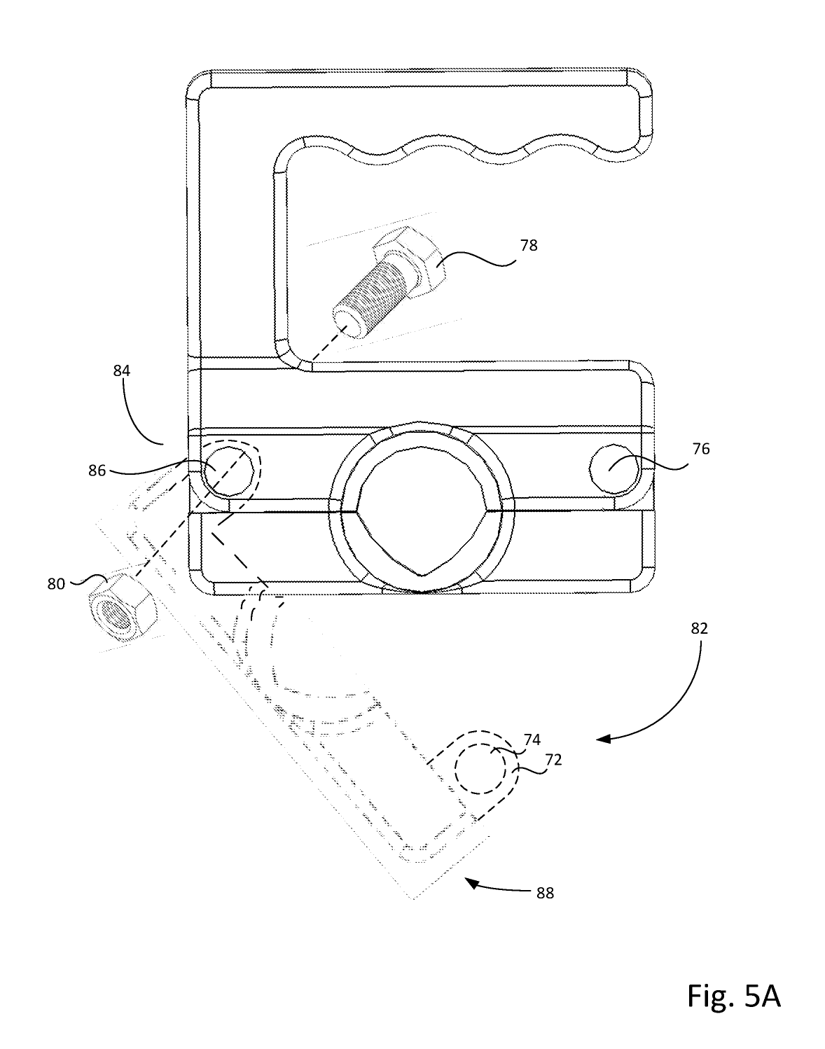

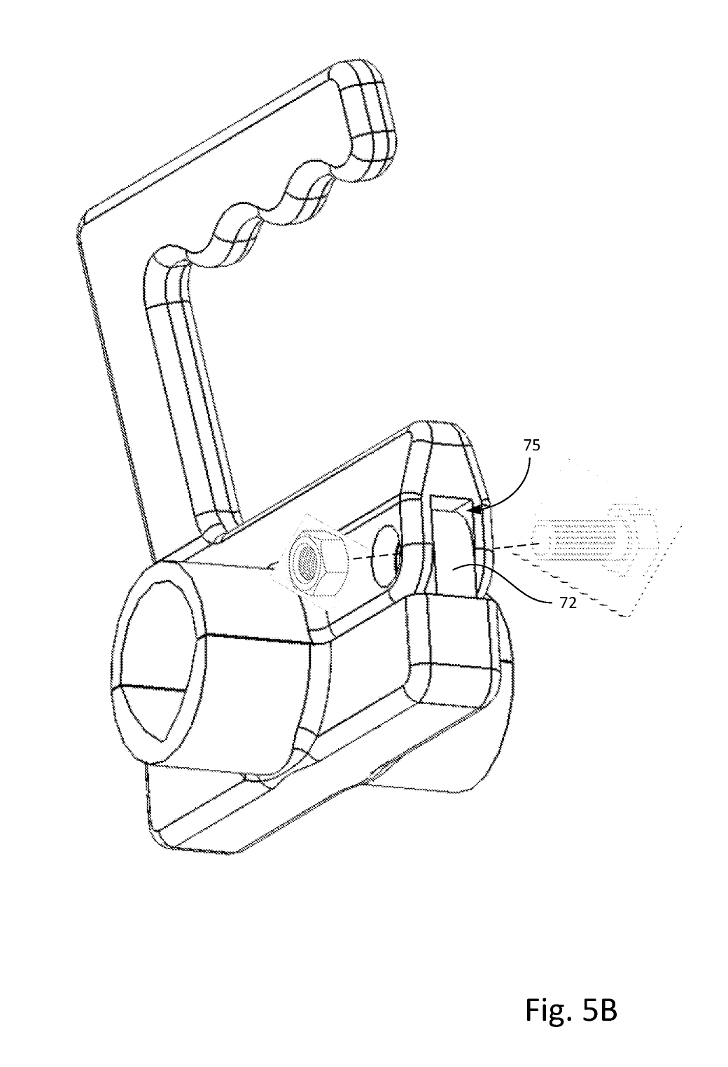

Referring to FIGS. 5A and 5B, the lower base can be attached to the upper base using a bracket pin assembly. A bracket 72 can include a bracket opening 74. The bracket is received in a slot 75 in the upper base the upper base has an opening 76 that aligns with opening 74 when the lower base is attached to the upper base. When the openings are aligned, a bolt 78 can be inserted into the openings securing the lower base to the upper base. A nut 80 can secure the bolt in the openings. The bracket pin assembly can be used as each lateral end of the lower and upper base so that when one bracket pin assembly is disengaged as shown by 82 and the other bracket pin assembly 84 is engaged, a hinge 86 attaches a rotating end of the lower base to the upper base, and allows a free end 88 of the lower base to rotate away from the upper base. This allows the rod assistance assembly to be installed or remove from a fishing rod without completely removing the lower base from the upper base. In one embodiment, the lower base snaps into the upper base without the need for a bolt or other detached fasteners. In one embodiment, the end disposed away from the hinge can include a locking assembly to secure the lower base to the upper case in a locked configuration.

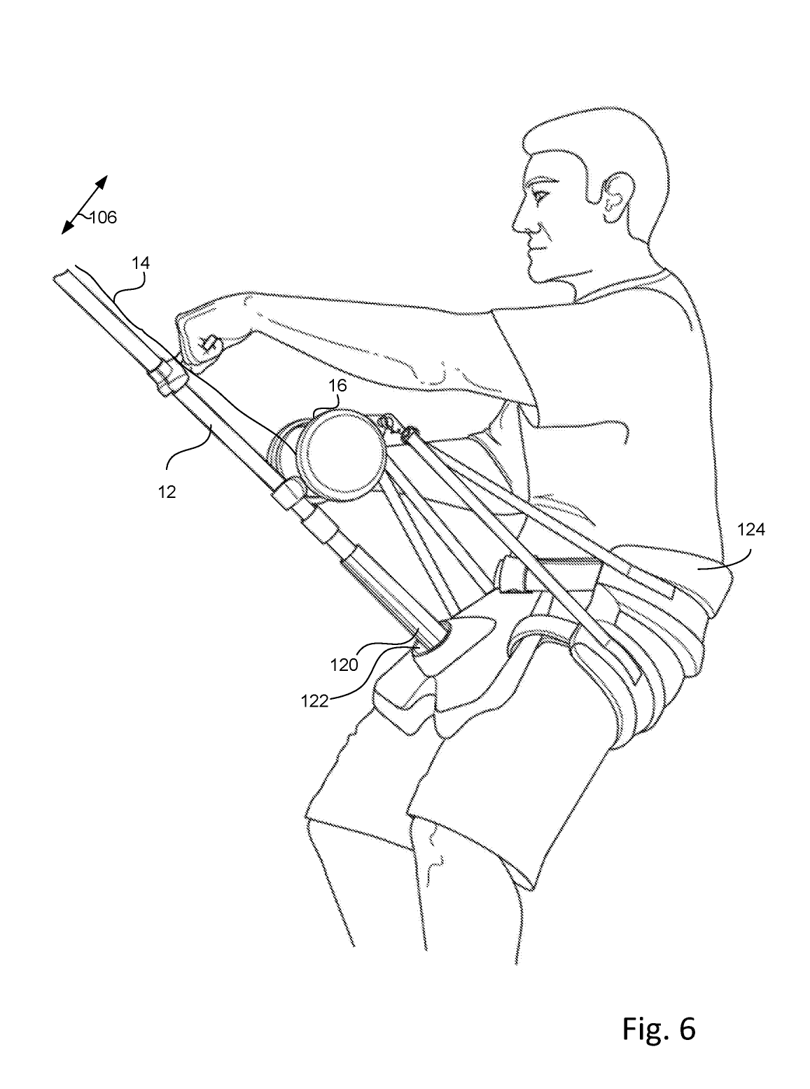

Referring to FIG. 6, the assembly is shown attached to a fishing rod, the proximal end of the fishing rod 120 can be placed in cup 122 of a fighting belt 124 worn by the user. The fulcrum point defined by the proximal end of the rod and the cup improve the “pump action” used when landing a fish. The pump action requires that an area of the rod, forward the reel, be pulled upwards in direction shown generally as 116. The handle of the invention allows a better grip by the fisherman on the rod, improved pump action, more efficient transfer of energy from the fisherman to the rod and increased mechanical advantage. The space allows the fishing line 14 to be disposed below the fisherman's hand without interfering with the ability to reel in line

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted by those skilled in the art, and that such modifications and variations are considered to be within the scope of this invention as defined by the appended claims.

What is claimed is:

1. A fishing rod assistance assembly comprising:
a base assembly having an upper base wherein the upper base includes an upper concave portion;
a lower base included in the base assembly configured for attachment to the upper base wherein the lower base includes a lower concave portion;
a rod opening defined by the upper concave portion and the lower concave portion;
a handle assembly attached to the upper base having a lateral vertical member and handle;
a handhold space defined by the upper base, lateral vertical member, and handle wherein the rod opening is dispose beneath the handhold space and the handhold space width extends beyond the diameter of the rod opening;
a handle angle in the range of 100° to 180° defined by a lateral vertical member line and a vertical line at a right angle to a bore line;
a lateral inner wall defined in the lower concave portion of the lower base configured to contact the fishing rod and apply compressive force to secure the rod in the rod opening; and,
a tool holder included in the lower base for receiving and removably securing a fastening tool to the lower base.

2. The assembly of claim 1 including an upper member removable attached to the upper base and lateral vertical member so that the handle can be removed from the base.

3. The assembly of claim 1 including a hinge configured to secure a rotating end of the lower base to the upper base and allowing a free end of the lower to rotate away from the upper base so that the fishing rod can be received in the rod opening.

4. The assembly of claim 1 including a rearward extension for contacting the fishing rod and configured to increase leverage on the fishing rod when the handle is pulled upwards.

5. The assembly of claim 1 including a forward extension for contacting the fishing rod and configured to increase leverage on the fishing rod when the handle is pulled upwards.

6. The assembly of claim 1 including bolt opening defined in the lower base and the upper base for receiving a bolt to secure the lower base to the upper base wherein the bolt opening s have a length wise bore that is perpendicular to a lengthwise axis extending through a bore defined by the rod opening.

7. The assembly of claim 1 including a lower flat area defined in the lower base.

8. A fishing rod assistance assembly comprising:
an upper base;
a lower base removably attached to the upper base;
a rod opening defined by the upper base and the lower base configured to receive a fishing rod;
a handle assembly attached to the upper base;
a handhold space defined by the handle assembly wherein the rod opening is dispose beneath the handhold space and the handhold space width extends beyond the diameter of the rod opening;
a lateral inner wall defined in the lower concave portion of the lower base configured to contact the fishing rod and apply compressive force to secure the rod in the rod opening; and,
a tool holder included in the lower base for receiving and removably securing a fastening tool to the lower base.

9. The assembly of claim 8 including a concave arc defined in a wall of the rod opening.

10. The assembly of claim 8 including a tool holder included in the lower base for receiving and removably securing a fastening tool to the lower base.

11. The assembly of claim 8 wherein the lower base is hingeably attached to the upper base.

12. The assembly of claim 8 including a handle included in the handle assembly and removable attached to the upper base.

13. The assembly of claim 12 including a handle angle of less than 180° in a rearward position and greater than 180° in a forward position.

14. A fishing rod assistance assembly comprising:
a base assembly;
a rod opening defined in the base assembly;
a handle assembly attached to the base assembly; and,
a handhold space included in the handle assembly wherein the rod opening is dispose beneath the handhold space and the handhold space width extends beyond the diameter of the rod opening.

15. The assembly of claim 14 including a handle angle in the range of 100° to 180° defined by a lateral vertical member line and a vertical line at a right angle to a bore line.

16. The assembly of claim 14 including a lateral inner wall defined in the rod opening configured to contact the fishing rod and apply compressive force to secure the rod in the rod opening.

17. The assembly of claim include including a lower base removable attached to an upper base.

18. The assembly of claim 17 wherein the lower base include a free end that can rotate award from the upper base.

19. The assembly of claim 14 including a handle removable attached to the handle assembly.

20. The assembly of claim 14 including a tool holder included in the base assembly for receiving and removably securing a fastening tool to the base assembly.
